(19) United States
(12) Patent Application Publication
(10) Pub. No.: US 2007/0110616 A1
(43) Pub. Date: May 17, 2007

(54) LEAD DETECTION SWAB KIT

(75) Inventor: Paul M. Blair, Jonesboro, GA (US)

Correspondence Address: Levenfeld Pearlstein, LLC (ILLINOIS TOOL WORKS), 2 North LaSalle Street, Suite 1300, CHICAGO, IL, 60602, US

(73) Assignee: ILLINOIS TOOL WORKS, INC., Glenview, IL (US)

(21) Appl. No.: 11/164,155

(22) Filed: Nov. 11, 2005

(51) Int. Cl. B01L 3/00

(52) U.S. Cl. 422/61

(57) ABSTRACT

A lead detection kit is for use in detecting the presence or absence of lead in a sample. The kit includes a label having spaces thereon indicated for the completion of information. The label has a lead indicating test strip mounted thereto that, when used, indicates the presence or absence of lead. A swab is included that has an abrasive tip. When the swab is rubbed on the surface of the sample, a portion of the sample is transfer onto the swab. The test strip is wetted with wetting solution, and the portion of sample is transferred onto the wetted test strip. The test strip changes color to indicate the presence of lead.

### BACKGROUND OF THE INVENTION

The present invention pertains to a kit for determining the presence of lead. More particularly, the present invention pertains to a kit for determining the presence or absence of lead and recording that presence or absence determination.

For many years, electronic component assembly relied upon materials, and specifically solder, that contained lead. Many countries are contemplating laws and other regulations that restrict the use of lead in solder. Moreover, even though industry trends are tending toward the use of lead-free materials, many components presently made and in use contain leaded solder.

In order to assure that personnel are protected from lead, it is desirable to test the solder on a printed circuit board prior to commencing work on the board. Known types of test devices use acid to transfer material (lead and other solder constituent materials) from the solder to media onto which a chemical indicator is applied to indicate the presence or absence of lead. In one known device, an acid-containing reagent is in a breakable vial or is pre-applied to a swab which is then rubbed on the surface of the solder. The reagent changes color in the presence of lead.

One of the drawbacks to this device or system is that a liquid, and likely an acid, is contacted with or applied to the solder on the board. This, or course has its inherent drawbacks. Another is that this system is merely a system to determine the presence or absence of lead and does not provide any means to record that determination.

Accordingly, there is a need for a lead detection kit that does not require the application of a liquid (acid solution) to the material being tested. Desirably, such a kit permits the recordation of such a determination.

### BRIEF SUMMARY OF THE INVENTION

A lead detection is used to detect the presence or absence of lead in a sample, such as that from a circuit board. The kit is intended or use where maintenance or rework is required on the sample, and it is desirable to determine, prior to work, whether there is lead in any of the materials in the sample. Such a kit eliminates the need for application of a liquid, such as an acid solution, to the material being tested.

The kit includes a label having spaces thereon indicated for the completion of information. The label has a lead indicating test strip mounted thereto that indicates the presence or absence of lead. The kit includes a swab having an abrasive tip.

The swab is rubbed on the surface of the sample to transfer a portion of the sample onto the swab. The test strip is wetted with a wetting solution, and the portion of sample is transferred onto the wetted test strip. The test strip changes color to indicate the presence of lead. Conversely, failure to change color indicates the absence of lead.

The label is preferably an adhesive backed label. Preferably, the label has a first removable portion indicating that the sample contains lead and a second removable portion indicating that the sample does not contain lead. The appropriate portion can be placed on the sample, e.g., the circuit board or component in which the circuit board resides.

The wetting solution is a lead detection activation solution, such as deionized water. The kit can further include a set of instructions for use of the kit.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is plan view of a lead detection swab kit embodying the principles of the present invention.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

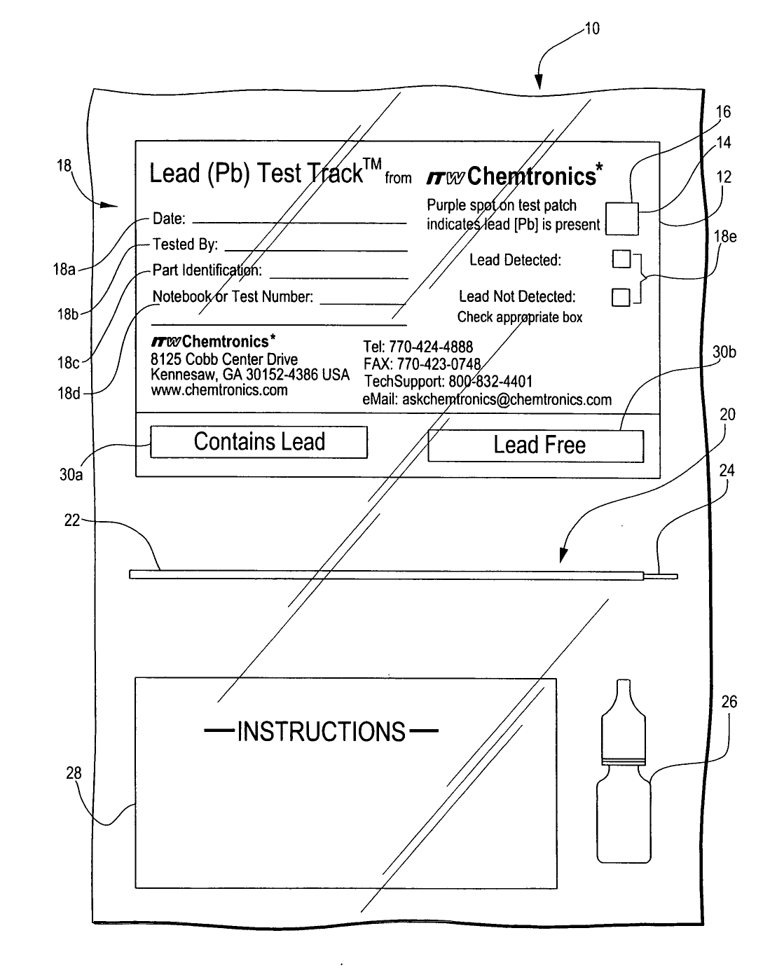

Referring now to the figures and in particular to FIG. 1 there is shown a lead detection test kit 10 embodying the principles of the present invention. The kit 10 includes tools to test for the presence or absence of lead on, for example, a printed circuit board. The kit 10 includes an adhesive label 12 that can be applied to, for example, the board, a component in which the board is installed, or any other surface for record keeping purposes. The label 12 includes a dried indicator 14, such as a test paper strip that is impregnated with an indicator 16 such as rhodizonate. The strip 14 is affixed to the label 12 to provide permanent or semi-permanent indication.

The label 12 further includes areas 18 in which specific information is to be completed. The information can include: the date 18a; identification of the individual performing the test 18b; identification of the part that is being tested 18c; a notebook or test number 18d; and indication 18e of whether lead is indicated by the test. Other and/or different information can also be included on the label 12 as desired.

The kit 10 also includes a swab 20. The swab 20 includes a handle 22 and a sampling head 24. The sampling head 24 is formed from an abrasive material that retains its integrity in use. That is, the abrasive material does not flake or rub off of the head 24 as it is rubbed on the material to be tested or on surface of the test strip 14. However the grit or roughness of the material cannot be so great as to fray the strip 14 when it is rubbed on the strip 14. The kit 10 further includes a wetting solution 26, which serves as a lead detection activation solution. The solution 26 brings the sample to be tested into intimate contact with the test strip 14 in a liquid environment. In a present kit 10, the solution 26 is water, preferably, deionized water.

The kit 10 includes an instruction sheet 28. The instructions 28 delineate the method carried out to test the sample. The instructions provide for grasping the swab 20 and holding it between the thumb and forefinger, by the handle 22 just above the head 24; rubbing or twisting the head 24 tip of the swab 20 on the solder joint being tested (to collect the sample) for 30 to 45 seconds; pressing the swab 20 firmly but without smashing the head 24 more than 1/16 inch; inspecting the head 24 of the swab 20 for gray residue from the joint, and if the head 24 is not gray, making sure that the joint is not covered in coating or contaminant, in which case the coating or contaminant must be removed from the joint to collect a good sample, and alternately selecting another joint for testing; placing a drop of lead detector activator solution 26 on the test strip 14; gently twisting the head 24 of the exposed swab 20 on the dampened test strip 14 for 30 to 45 seconds assuring that the head 24 is making contact with the strip 14 but is not penetrating (tearing through) the strip 14 material; visually examining the test strip 14 to determine whether the test strip 14 changes color (to red or purple) within about 2 to about 15 minutes indicating that lead is present; recording the results and notations (information) on the label 12 in the appropriate spaces 18a-e and storing the label 12 for future records or affixing the label 12 to other paper; and optionally securing the appropriate label portion “Contains Lead” 30a or “No Lead” (or “Lead Free”) 30b to the tested circuit board.

A method for testing and marking or labeling a sample includes applying the label 12 to a sample or a component that contains the sample, rubbing the swab head 24 on the sample to transfer a portion of the sample onto the swab 20, wetting the test strip 14 with an activator solution 26 and rubbing the swab head 24 on the test strip 14 to transfer at least some of the sample from the head 24 onto the strip 14. If the test strip 14 changes color, then lead is present, and if the test strip 14 does not change color then lead is not present. The results (information) can be marked in the appropriate spaces 18a-e on the label 12. If the label 12 contains removable portions or tabs 30a,b that indicate the presence or absence of lead, the appropriate tab (“Contains Lead” 30a or “No Lead” (or “Lead Free”) 30b label portion) can be remove from the label 12 and applied to the sample, e.g., the circuit board or the component that contains the circuit board.

All patents referred to herein, are hereby incorporated herein by reference, whether or not specifically do so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A lead detection kit for detecting the presence or absence of lead in a sample, comprising:
a label having spaces thereon indicated for the completion of information, the label having a lead indicating test strip mounted thereto that indicates the presence or absence of lead; and
a swab having an abrasive tip,
wherein the swab is rubbed on the surface of the sample to transfer a portion of the sample onto the swab and wherein the test strip is wetted with wetting solution, and wherein the portion of sample is transferred onto the wetted test strip, the test strip changing color to indicate the presence of lead.

2. The lead detection kit in accordance with claim 1 wherein the label is an adhesive backed label.

3. The lead detection kit in accordance with claim 1 wherein the wetting solution is a lead detection activation solution.

4. The lead detection kit in accordance with claim 3 wherein the lead detection activation solution is water.

5. The lead detection kit in accordance with claim 1 wherein the kit includes a set of instructions for use of the kit.

6. The lead detection kit in accordance with claim 2 wherein the label has a first removable tab indicating that the sample contains lead and a second removable tab indicating that the sample does not contain lead.

7. A method for detecting and recording the presence or absence of lead in a sample, comprising the steps of:
providing a label having spaces thereon indicated for the completion of information, the label having a lead indicating test strip mounted thereto that indicates the presence or absence of lead;
rubbing a swab on the surface of the sample to transfer a portion of the sample onto the swab;
wetting the test strip with an activator solution;
rubbing the swab on the test strip to transfer at least some of the sample from the swab onto the strip;
determining whether the test strip changes color, indicating the presence of lead; and
noting whether the test strip changed color.

8. The method in accordance with claim 7 including the step of adhering the label to the sample or to a component in which the sample resides.

9. The method in accordance with claim 7 including the step of noting whether the test strip changed color on the label.

10. The method in accordance with claim 7 including the step of applying a portion of the label to the sample to indicate whether the test strip changed color.
